(19) United States
(12) Patent Application Publication
(10) Pub. No.: US 2017/0180533 A1
(43) Pub. Date: Jun. 22, 2017

(54) MICROPHONE SWITCHING SYSTEM AND METHOD FOR MOBILE TERMINAL

(71) Applicant: HUIZHOU TCL MOBILE COMMUNICATION CO., LTD, Huizhou City, Guangdong (CN)

(72) Inventor: Qiong CHEN, Huizhou City, Guangdong (CN)

(21) Appl. No.: 15/311,284

(22) PCT Filed: Apr. 7, 2016
(86) PCT No.: PCT/CN2016/078645

§ 371 Date: Nov. 15, 2016

(30) Foreign Application Priority Data
Jul. 22, 2015 (CN) 201510432568.5

(51) Int. Cl. H04M 1/725; H04R 3/00

(52) U.S. Cl. CPC H04M 1/725; H04R 3/00; H04M 2250/12; H04R 2499/11

(57) ABSTRACT

A microphone switching method and system for a mobile terminal is provided. When the mobile terminal detects that an incoming call is received, an angle and position information of the mobile terminal is obtained and whether the mobile terminal is placed upside down is determined according to the angle and position information. If yes, the function of a first microphone disposed on an upper portion is switched to receive a voice signal and the function of a second microphone disposed on a lower portion is switched to receive the noise signal. In this way, even though the mobile terminal is placed upside down, a user can still make voice communications well using the mobile terminal.

### TECHNICAL FIELD OF THE INVENTION

The present invention relates to an intelligent device, and more particularly to a microphone switching system and method for a mobile terminal.

### BACKGROUND OF THE INVENTION

As mobile handheld devices rapidly spread and improvement on intelligence of the terminal devices is further requested by users, how to make cell phones become more efficient in power saving, more intelligent, and more close to habits of users in their real lives has become an imperative problem to be solved. At a current stage, many manufacturers exert more and more effort to improve user experiences. For a cell phone, answering phone calls is currently a primary function. How to carry out voice communications despite the ways to pick up the phone has become a current problem that various manufacturers are trying to solve.

Generally, a smartphone uses two or more than two microphones. One of them is for normal voice communications, while the other one serves as a noise-cancelling microphone used in a handheld mode. When a user carelessly places the cell phone upside down, a mouth of the user will be close to the noise-cancelling microphone in answering the phone call. This will affect communication quality during voice communications and cause much inconvenience for the user.

Therefore, there is a need to improve the existing skills.

### SUMMARY OF THE INVENTION

In view of the drawbacks in the existing skills, the objective of the present invention is to provide a microphone switching method and system for a mobile terminal for overcoming being unable to make normal voice communications in the existing skills caused when the mobile terminal is placed upside down such that a mouth of a user is close to a microphone receiving a voice signal.

To solve the technical problems, the technical schemes provided by the present invention are described below.

A microphone switching method for a mobile terminal, comprising:

obtaining an angle and position information of the mobile terminal when the mobile phone detect that an incoming call is received, and determining, based on the obtained angle and the position information, whether the mobile terminal is placed upside down; determining that the mobile terminal is placed upside down if the angle and position information indicates that the mobile terminal is inclined at an angle exceeding 180 degrees relative to a horizontal direction; switching a function of a first microphone disposed on an upper portion of the mobile terminal from receiving a noise signal to receiving a voice signal, switching a function of a second microphone disposed on a lower portion of the mobile terminal from receiving the voice signal to receiving the noise signal, switching over audio paths and audio configuration files adopted by the first microphone and the second microphone, and ending the process or waiting for a next instruction if the mobile terminal is determined to be placed upside down according to the obtained angle and position information; and controlling the first microphone on the upper portion of the mobile terminal to receive the noise signal and controlling the second microphone on the lower portion of the mobile terminal to receive the voice signal if the mobile terminal is determined not to be placed upside down according to the obtained angle and position information.

In the microphone switching method, switching over the audio paths and the audio configuration files adopted by the first microphone and the second microphone comprises: initializing, by receiving an instruction from an application processor, input and output circuits connected with the first microphone and the second microphone; and arranging different audio paths for the first microphone and the second microphone after the initialization.

In the microphone switching method, a speaker corresponding to the second microphone is switched from being the speaker to a receiver in switching the functions of the first microphone and the second microphone.

A microphone switching method for a mobile terminal, comprising: obtaining an angle and position information of the mobile terminal when the mobile terminal detect that an incoming call is received, and determining, based on the obtained angle and position information, whether the mobile terminal is placed upside down; switching a function of a first microphone disposed on an upper portion of the mobile terminal from receiving a noise signal to receiving a voice signal, switching a function of a second microphone disposed on a lower portion of the mobile terminal from receiving the voice signal to receiving the noise signal, and ending the process or waiting for a next instruction if the mobile terminal is determined to be placed upside down according to the obtained angle and position information; and controlling the first microphone on the upper portion of the mobile terminal to receive the noise signal and controlling the second microphone on the lower portion of the mobile terminal to receive the voice signal if the mobile terminal is determined not to be placed upside down according to the obtained angle and position information.

In the microphone switching method, determining, based on the obtained angle and position information, whether the mobile terminal is placed upside down comprises: determining, based on the angle and position information, an inclination angle of the mobile terminal in relative to a horizontal direction, and determining that the mobile terminal is placed upside down if the inclination angle exceeds 180 degrees.

In the microphone switching method, the method further comprises: switching over audio paths and audio configuration files adopted by the first microphone and the second microphone if the mobile terminal is determined to be placed upside down according to the obtained angle and position information.

In the microphone switching method, after switching over the audio paths and the audio configuration files adopted by the first microphone and the second microphone, said method further comprises: initializing, by receiving an instruction from an application processor, input and output circuits connected with the first microphone and the second microphone; and arranging different audio paths for the first microphone and the second microphone after the initialization.

In the microphone switching method, a speaker corresponding to the second microphone is switched from being the speaker to a receiver in switching the functions of the first microphone and the second microphone.

A microphone switching system for a mobile terminal, comprising at least two microphones, said system further comprising: an incoming call detection module configured to detect whether an incoming call is received by the mobile terminal; an upside down determining module configured to obtain an angle and position information of the mobile terminal when the mobile terminal receives the incoming call, and determine, based on the obtained angle and position information, whether the mobile terminal is placed upside down; a first control module configured to switch a function of a first microphone on an upper portion of the mobile terminal from receiving a noise signal to receiving a voice signal, switch a function of a second microphone on a lower portion of the mobile terminal from receiving the voice signal to receiving the noise signal, and end the process or wait for a next instruction if the mobile terminal is determined to be placed upside down according to the obtained angle and position information; and a second control module configured to control the first microphone on the upper portion of the mobile terminal to receive the noise signal and control the second microphone on the lower portion of the mobile terminal to receive the voice signal if the mobile terminal is determined not to be placed upside down according to the obtained angle and position information.

In the microphone switching system, the upside down determining module comprises an inclination angle determining unit configured to determine, based on the angle and position information, an inclination angle of the mobile terminal in relative to a horizontal direction, and determine that the mobile terminal is placed upside down if the inclination angle exceeds 180 degrees.

In the microphone switching system, the first control module comprises a switching activation unit configured to switch over audio paths and audio configuration files adopted by the first microphone and the second microphone.

In the microphone switching system, the switching activation unit comprises an activation sub-unit configured to initialize, by receiving an instruction from an application processor, input and output circuits connected with the first microphone and the second microphone, and arrange different audio paths for the first microphone and the second microphone after the initialization.

In the microphone switching system, the system further comprises a synchronous switching module configured to switch a speaker corresponding to the second microphone is switched from being the speaker to a receiver in switching the functions of the first microphone and the second microphone.

Beneficial Effects:

The present invention provides a microphone switching method and system for a mobile terminal. Whether an incoming call is received by the mobile terminal is detected. When the mobile terminal detects that an incoming call is received, angle and position information of the mobile terminal is obtained and whether the mobile terminal is placed upside down is determined according to the angle and position information. If the mobile terminal is placed upside down, the function of a first microphone on an upper portion of the mobile terminal is switched from receiving a noise signal to receiving a voice signal and the function of a second microphone on a lower portion of the mobile terminal is switched from receiving the voice signal to receiving the noise signal. In this way, even though the mobile terminal held on a hand of a user is placed upside down, the user can still make voice communications well using the mobile terminal. This is a convenience for the user.

### BRIEF DESCRIPTION OF THE DRAWINGS

FIG. 1 is a flowchart of a microphone switching method for a mobile terminal in accordance with the present invention.

FIG. 2 is a schematic diagram showing a default reference orientation in the method of the present invention.

FIG. 3 is a schematic structural diagram showing microphones and their corresponding speakers disposed on a mobile terminal of the present invention.

FIG. 4 is a schematic structural diagram showing a microphone switching system for a mobile terminal in accordance with the present invention.

FIG. 5 is a schematic diagram showing a hardware structure of the microphone switching system in accordance with the present invention.

### DETAILED DESCRIPTION OF THE INVENTION

To make the objectives, technical schemes, and advantages of the present invention more clear and specific, the present invention is described in further detail below with reference to the embodiments accompanied with the appending drawings. It should be understood that the specific embodiments described herein are merely for explaining the present invention and the present invention is not limited thereto.

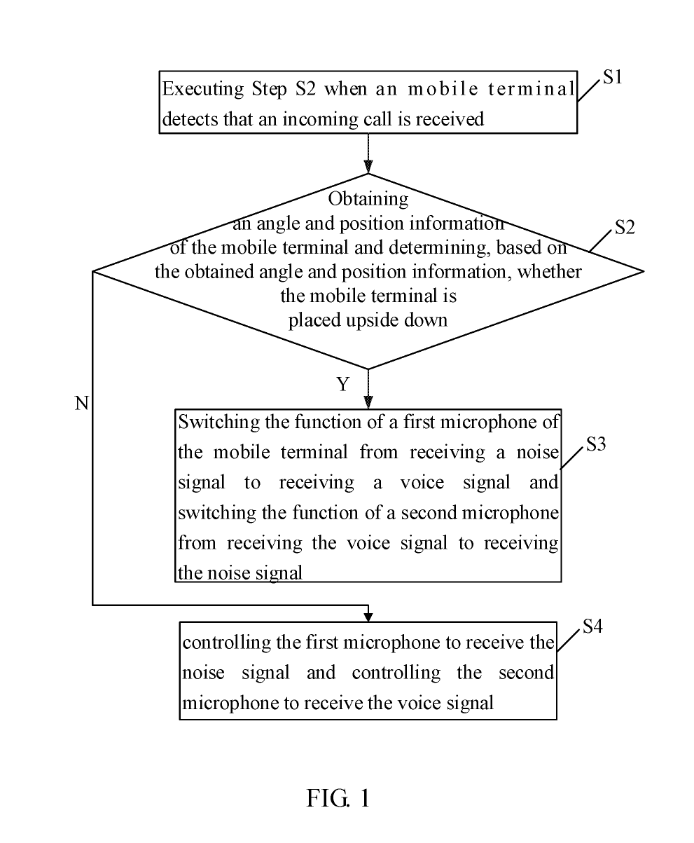

As shown in FIG. 1, the present invention provides a microphone switching method for a mobile terminal, which includes the following steps.

In Step S1, execute Step S2 when the mobile terminal detects that an incoming call is received.

The objective of the present invention is to avoid obstruction of voice communications caused when the mobile terminal is placed upside down when the mobile terminal is used by a user to make a voice call. Therefore, a first priority is to detect whether the mobile terminal receives an incoming call. When the mobile terminal detects that an incoming call is received, the next step is triggered.

In Step S2, angle and position information of the mobile terminal is obtained and whether the mobile terminal is placed upside down is determined based on the obtained angle and position information. If the mobile terminal is placed upside down, execute Step S3; otherwise, execute Step S4.

The mobile terminal comprises a sensor disposed therein for obtaining the angle and position information of the mobile terminal. Preferably, a gyroscope sensor is utilized to obtain data of movement made by the mobile terminal when the user holds the mobile terminal in answering a call after the mobile terminal receives an incoming call. The gyroscope sensor can transmit the data to an application processor connected with the gyroscope sensor to obtain an inclination angle of the mobile terminal at the moment with respect to a default reference orientation.

Specifically, the default reference orientation can be set as the coordinates corresponding to a horizontal direction or be set as a vertical direction as long as it can represent an inclination angle of the mobile terminal and can be used to determine whether the mobile terminal is placed upside down with respect to the user.

In order to predict more accurately whether the mobile terminal is placed upside down on the hand of the user, the application processor can be used to determine an inclination angle of the mobile terminal at the instant moment the user answers the call.

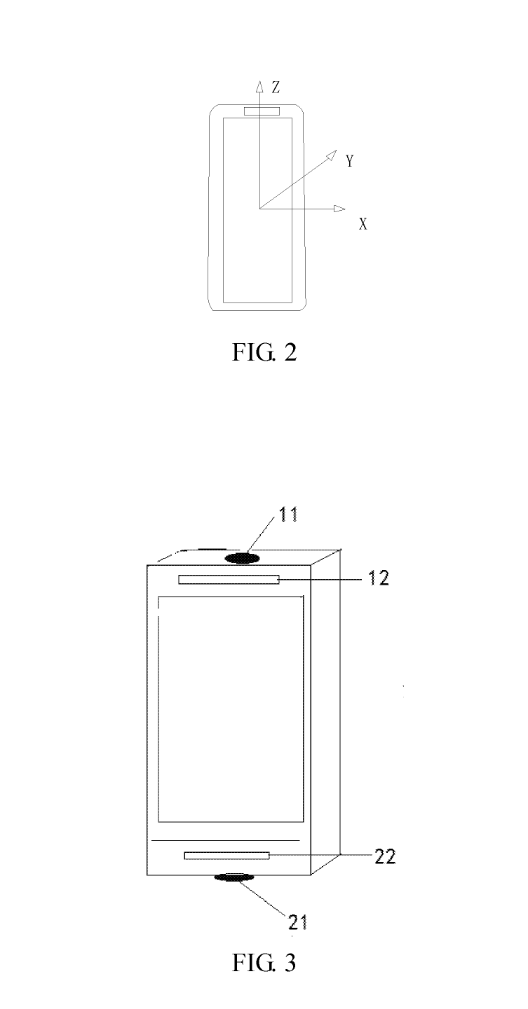

It can be known that if the default reference orientation is set corresponding to the horizontal direction (i.e., the horizontal direction in the front of the mobile terminal corresponds to a positive orientation for the default reference orientation as shown in FIG. 2). The application processor calculates, according to the angle and position information of the mobile terminal obtained from the gyroscope sensor, a current inclination angle of the mobile terminal. If the inclination angle is greater than 180 degrees, the mobile terminal is determined to be in an upside-down state and Step S3 is to be executed; otherwise, the mobile terminal is determined not to be placed upside down and Step S4 is to be executed.

In Step S3, the function of a first microphone disposed on an upper portion of the mobile terminal is switched from receiving a noise signal to receiving a voice signal, the function of a second microphone disposed on a lower portion of the mobile terminal is switched from receiving the voice signal to receiving the noise signal, and the process is terminated or waits for a next instruction.

As shown in FIG. 3, the mobile terminal generally comprises two microphones. One of them is a noise-canceling microphone 11, which is disposed on an upper portion of the mobile terminal and is configured to receive a noise signal. A speaker 12 corresponding to the microphone 11 is disposed as well. The other one is a voice receiving microphone 21, which is disposed on a lower portion of the mobile terminal and is configured to receive a voice signal generated during the call. Also, a speaker 22 corresponding to the microphone 21 is disposed.

When the mobile terminal is determined to be placed upside down in the aforesaid Step S2 after the user answers the incoming call using the mobile terminal, the functions of the upper and lower microphones are switched. Specifically, this step further includes the following content.

Switching the functions of the first microphone and the second microphone is carried out by switching over audio paths and audio configuration files adopted by the first microphone and the second microphone.

After the application processor determines that the mobile terminal is placed upside down, the application processor transmits a control instruction to initialize input and output circuits connected with the first microphone and the second microphone and rearrange different audio paths for the first microphone and the second microphone.

Specifically, path deployment files are loaded by the application processor and the microphones and the speakers are powered at the same time. Meanwhile, the function of the speaker corresponding to the second microphone is switched as being a receiver speaker, and its primary output power is switched from 600 MW to 20 MW.

In Step S4, the first microphone on the upper portion of the mobile terminal is controlled to receive the noise signal and the second microphone on the lower portion of the mobile terminal is controlled to receive the voice signal.

If the mobile terminal is not placed upside down, there is no need to switch the functions of the upper and lower microphones in this step. This step can directly use predetermined audio paths for the input and output of the audio signals.

In order to describe the present invention in more detail, specific embodiments are taken as examples for illustrating the aforesaid method in a more specific way.

Specifically, the mobile terminal is a cell phone in the present embodiment.

When the cell phone receives the incoming call, the user takes the cell phone out and the gyroscope sensor disposed in the cell phone starts initialization. The interface of the sensor is an I2C interface configured to carry out instruction and data communication. The sensor is a 9-axis gyroscope capable of providing more accurate data output. The default reference orientation is preset as a positive orientation in the front of the cell phone. By making a comparison between the data obtained by the gyroscope sensor and the reference orientation, a current inclination angle of the cell phone with respect to the reference orientation is calculated. When the inclination angle is greater than a certain angle, the cell phone is determined to be in an upside-down state. Meanwhile, it is triggered to transmit data to inform the application processor to change the user interface (UI) and modify the audio paths and the audio device configuration files preserved in the file system. In such a manner, the microphone, in front of the cell phone, originally configured to receive the voice communication signal is switched to receive the noise signal, and the microphone disposed in the upper portion of the mobile terminal and originally configured to receive the noise signal is switched to receive the voice communication signal. Further, the input and output module is re-initialized using the instruction transmitted from the application processor, and different gains are deployed for the microphones of different channels to assure that different indicators are provided corresponding to different functions of the microphones and assure that it can pass the subsequent voice tests in a stable way.

Also, a speaker corresponding to the second microphone is switched from being the speaker to a receiver in switching the functions of the first microphone and the second microphone. Therefore, automatic switching the functions of the microphones on the cell phone based on the angle and position information of the cell phone can be carried out. It is convenient for a user in voice communication.

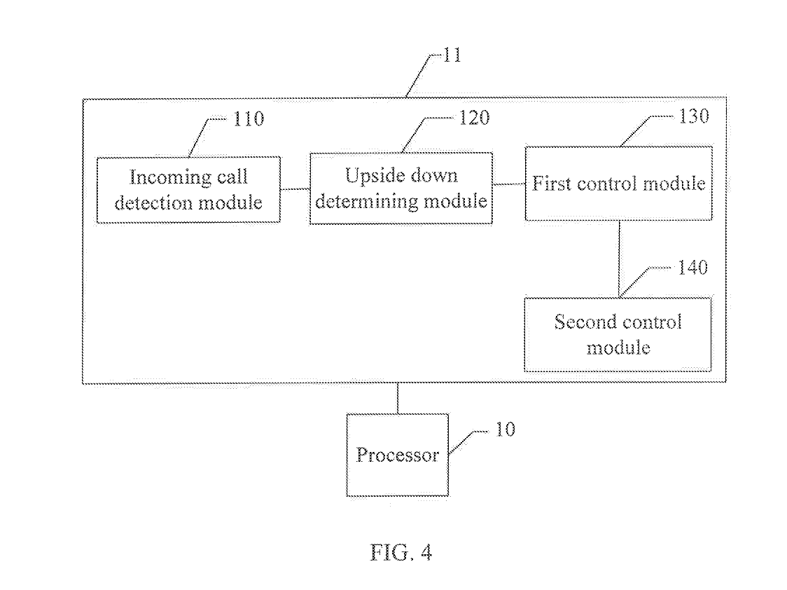

On the basis of the afore-described method, the present invention further provides a microphone switching system for a mobile terminal. As shown in FIG. 4, the system at least comprises two microphones and comprises the following components.

An incoming call detection module 110 is configured to detect whether an incoming call is received by the mobile terminal.

An upside down determining module 120 is configured to obtain angle and position information of the mobile terminal when the mobile terminal receives the incoming call, and determine, based o the obtained angle and position information, whether the mobile terminal is placed upside down.

A first control module 130 is configured to switch the function of a first microphone on an upper portion of the mobile terminal from receiving a noise signal to receiving a voice signal, switch the function of a second microphone on a lower portion of the mobile terminal from receiving the voice signal to receiving the noise signal, and end the process or wait for a next instruction if the mobile terminal is placed upside down.

A second control module 140 is configured to control the first microphone on the upper portion of the mobile terminal to receive the noise signal and control the second microphone on the lower portion of the mobile terminal to receive the voice signal if the mobile terminal is not placed upside down.

The upside down determining module 120 comprises an inclination angle determining unit configured to determine, based on the angle and position information, an inclination angle of the mobile terminal in relative to a horizontal direction, and determine that the mobile terminal is placed upside down if the inclination angle exceeds 180 degrees.

The first control module 130 comprises a switching activation unit configured to switch over audio paths and audio configuration files adopted by the first microphone and the second microphone.

The switching activation unit comprises an activation sub-unit configured to initialize, by receiving an instruction from an application processor, input and output circuits connected with the first microphone and the second microphone, and then arrange different audio paths for the first microphone and the second microphone.

The system further comprises a synchronous switching module configured to switch a speaker corresponding to the second microphone from being the speaker to a receiver in switching the functions of the first microphone and the second microphone.

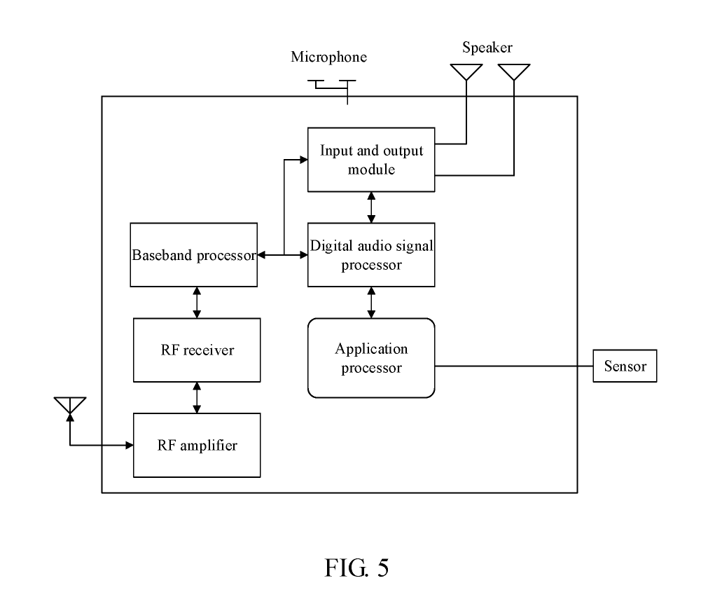

FIG. 5 is a schematic diagram showing a hardware structure of the system in accordance with the present invention. As shown in FIG. 5, the hardware structure mainly includes an input and output module, an audio system module, a digital audio signal processor, an application processor, and a gyroscope sensor.

As to the input and output module, a microphone with a Micro-Electro-Mechanical System (MEMS) digital interface obtains an external audio signal by high-sensitive peripheral components. The digital microphone is high sensitive to high frequency signals and possesses high sampling rate, and possesses greater consistency, therefore can produce a voice signal using a better bandwidth.

As to the audio system module, it provides a digital and analog audio input interface and additionally provides a dedicated audio interface connected with an audio signal processor so as to be convenient to connect to the peripheral components. Also, the audio system module transforms the external voice analog signals into digital signals using an analog-to-digital converter disposed therein.

As to the digital audio signal processor, audio data processing will occupy a large amount of resources, and therefore this part can be dealt with the digital audio signal processor to share the load of the application processor. In addition, the efficiency is high and the power consumption is low. It needs a speaker switching function be provided to a control interface for carrying out digital signal processing (DSP) due to the use of a 2-in-1 speaker.

As to the application processor, it receives an interrupt instruction transmitted from the digital audio signal processor to control upper-layer applications and additionally provides an interface to connect with the gyroscope sensor.

The present invention provides a microphone switching method and system for a mobile terminal. Whether an incoming call is received by the mobile terminal is detected. When the mobile terminal detects that an incoming call is received, angle and position information of the mobile terminal is obtained and whether the mobile terminal is placed upside down is determined according to the angle and position information. If the mobile terminal is placed upside down, the function of a first microphone on an upper portion of the mobile terminal is switched from receiving a noise signal to receiving a voice signal and the function of a second microphone on a lower portion of the mobile terminal is switched from receiving the voice signal to receiving the noise signal. In this way, even though the mobile terminal held on a hand of a user is placed upside down, the user can still make voice communications well using the mobile terminal. This is a convenience for the user.

It should be understood that those of ordinary skill in the art may make equivalent modifications or variations according to the technical schemes and invention concepts of the present invention, but all such modifications and variations should be within the appended claims.

1-4. (canceled)

5. A microphone switching method for a mobile terminal, comprising:
obtaining an angle and position information of the mobile terminal when the mobile terminal detects that an incoming call is received;
determining, based on the obtained angle and position information, whether the mobile terminal is placed upside down;
switching a function of a first microphone disposed on an upper portion of the mobile terminal from receiving a noise signal to receiving a voice signal, switching a function of a second microphone disposed on a lower portion of the mobile terminal from receiving the voice signal to receiving noise signal, re-arranging connections paths for the first microphone and the second microphone, and switching over audio configuration files adopted by the first microphone and the second microphone, if the mobile terminal is determined to be placed upside down according to the obtained angle and position information; and
controlling the first microphone on the upper portion of the mobile terminal to receive the noise signal and controlling the second microphone on the lower portion of the mobile terminal to receive the voice signal if the mobile terminal is determined not to be placed upside down according to the obtained angle and position information.

6. The microphone switching method according to claim 5, wherein determining, based on the obtained angle and position information, whether the mobile terminal is placed upside down comprises:
determining, based on the angle and position information, an inclination angle of the mobile terminal in relative to a horizontal direction, and determining that the mobile terminal is placed upside down if the inclined angle exceeds 180 degrees.

7. (canceled)

8. The microphone switching method according to claim 4, wherein the re-arranging connection paths for the first microphone and the second microphone comprises:
initializing, by receiving an instruction from an application processor, input and output circuits connected with the first microphone and the second microphone; and
switching over connection paths of the first microphone and the second microphone after the initialization.

9. The microphone switching method according to claim 5, wherein a function of a speaker corresponding to the second microphone is switched from being a system speaker to a receiver in switching the functions of the first microphone and the second microphone.

10-12. (canceled)

13. A microphone switching system for a mobile terminal, comprising at least two microphones, said system further comprising:
an incoming call detection module configured to detect whether an incoming call received by the mobile terminal;
an upside down determining module configured to obtain an angle and position information of the mobile terminal when the mobile terminal receives the incoming call, and determine, based on the obtained angle and position information, whether the mobile terminal is placed upside down;
a first control module configured to switch a function of a first microphone disposed on an upper portion of the mobile terminal from receiving a noise signal to receiving a voice signal, switch a function of a second microphone disposed on a lower portion of the mobile terminal from receiving the voice signal to receiving the noise signal, re-arranging connection paths for the first microphone and the second microphone, and switch over audio configuration files adopted by the first microphone and the second microphone, if the mobile terminal is determined to be placed upside down according to the obtained angle and position information; and
a second control module configured to control the first microphone on the upper portion of the mobile terminal to receive the noise signal and control the second microphone on the lower portion of the mobile terminal to receive the voice signal if the mobile terminal is determined not to be placed upside down according to the obtained angle and position information.

14. The microphone switching system according to claim 13, wherein the upside down determining module comprises an inclination angle determining unit configured to determine, based on the angle and position information, an inclination angle of the mobile terminal in relative to a horizontal direction, and determine that the mobile terminal is placed upside down if the inclined angle exceeds 180 degrees.

15. (canceled)

16. The microphone switching system according to claim 13, wherein the first control module comprises a switching activation unit, which comprises an activation sub-unit configured to initialize, by receiving an instruction from an application processor, input and output circuits connected with the first microphone and the second microphone, and switch over connection paths of the first microphone and the second microphone after the initialization.

17. The microphone switching system according to claim 13, further comprising a synchronous switching module configured to switch a function of a speaker corresponding to the second microphone from being a system speaker to a receiver in switching the functions of the first microphone and the second microphone.

18-20. (canceled)

21. A microphone switching method for a mobile terminal comprising a gyroscope, a first microphone, and a second microphone, the method comprising:
in response to the mobile terminal receiving an incoming call, determining, using the gyroscope, whether the mobile terminal is upside down;
transmitting, by an application processor, a control instruction to initialize input and output circuits connected with a first microphone and a second microphone of the mobile terminal and re-arrange connection paths of the first microphone and the second microphone to switch a function of the first microphone from receiving a noise signal to receiving a voice signal and switch a function of the second microphone from receiving the voice signal to receiving the noise signal, if the mobile terminal is determined to be placed upside down;
controlling the first microphone and the second microphone to receive the noise signal and the voice signal, respectively, if the mobile terminal is determined not to be placed upside down.

22. The microphone switching method according to claim 21, wherein determining whether the mobile terminal is upside down comprises:
transmitting, by the gyroscope, data of movement made by the mobile terminal to an application processor of the mobile terminal; and
calculating, by the application processor using the data, an inclination angle of the mobile terminal with respect to a default reference orientation pre-set corresponding to a horizontal direction.

23. The microphone switching method according to claim 21, further comprising switching over audio configuration files adopted by the first microphone and the second microphone if the mobile terminal is determined to be placed upside down.

24. The microphone switching method according to claim 21, wherein a function of a speaker corresponding to the second microphone is switched from the a system speaker to a receiver in switching the functions of the first microphone and the second microphone.
